(19) United States
(12) Patent Application Publication
(10) Pub. No.: US 2011/0285631 A1
(43) Pub. Date: Nov. 24, 2011

(54) INFORMATION PROCESSING APPARATUS AND METHOD OF DISPLAYING A VIRTUAL KEYBOARD

(75) Inventors: Akira Imamura, Hamura-shi (JP); Hiroshi Aiba, Ome-shi (JP)

(73) Assignee: KABUSHIKI KAISHA TOSHIBA, Tokyo (JP)

(21) Appl. No.: 13/111,790

(22) Filed: May 19, 2011

(30) Foreign Application Priority Data
May 21, 2010 (JP) 2010-117737

(51) Int. Cl. G06F 3/041

(52) U.S. Cl. 345/168

(57) ABSTRACT

According to one embodiment, an information processing apparatus includes a first touch screen, a second touch screen display, and a display module. The display module is configured to display a first virtual keyboard includes first virtual keys in order to input key codes on the first touch screen display, and to display a second virtual keyboard includes second virtual keys in order to input key codes on the second touch screen display.

### CROSS-REFERENCE TO RELATED APPLICATIONS

This application is based upon and claims the benefit of priority from Japanese Patent Application No. 2010-117737, filed May 21, 2010; the entire contents of which are incorporated herein by reference.

### FIELD

Embodiments described herein relate generally to an information processing apparatus, which inputs a key data using a virtual keyboard, and to a method of displaying a virtual keyboard.

### BACKGROUND

The following technique has been now developed. The technique displays a virtually indicated keyboard (hereinafter, referred to as a virtual keyboard) in place of a keyboard having a plurality of physical keys, and detects a user's operating position to output a key code in accordance with the detected position.

Usually, most of apparatuses have one screen only; therefore, a virtual keyboard is displayed on the screen. Recently, an apparatus having two screens is brought on the market. The apparatus having two screens is used in the following manner. Specifically, the direction of the apparatus is rotated by 90°, and user holds the apparatus in the form that the foregoing two screens are horizontally in line as if he reads a book in a state of carrying it in his both hands.

In this case, if a virtual keyboard is displayed on one screen, the virtual keyboard is displayed in a state of being rotated by 90° in accordance with the direction of the apparatus. Moreover, when the direction of the apparatus is rotated by 90°, the screen is changed from a landscape orientation to a portrait orientation. When a landscape-format virtual keyboard is displayed in portrait orientation, the virtual keyboard is displayed in a reduced state. For this reason, the size of virtual keys in the virtual keyboard becomes smaller and the user finds it hard to operate the virtual keyboard of the apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an information processing apparatus according to one embodiment.

FIG. 2 is an exemplary view showing one example of a virtual keyboard display on a touch screen display of an information processing apparatus according to one embodiment.

FIG. 3 is an exemplary top plan view showing a state that user has a rotated computer 10 in his hand.

FIG. 4 is an exemplary block diagram showing the configuration of a key input control program used by an information processing apparatus according to one embodiment.

FIG. 5 is an exemplary block diagram showing the configuration of a display control program according to one embodiment.

FIG. 6 is an exemplary flowchart to explain the procedure of making a change of a portrait display and a landscape display according to one embodiment.

FIG. 7 is an exemplary top plan view showing a computer in which a landscape-mode virtual keyboard according to one embodiment is displayed.

FIG. 8 is an exemplary top plan view showing a computer in which a portrait-mode virtual keyboard according to one embodiment is displayed.

FIG. 9 is an exemplary top plan view showing a computer in which a landscape-mode virtual keyboard according to one embodiment is displayed.

FIG. 10 is an exemplary top plan view showing a computer in which a portrait-mode virtual keyboard according to one embodiment is displayed.

FIG. 11 is an exemplary top plan view showing a computer in which a portrait-mode virtual keyboard according to one embodiment is displayed.

FIG. 12 is an exemplary top plan view showing a computer in which a landscape-mode virtual keyboard according to one embodiment is displayed.

FIG. 13 is an exemplary top plan view showing a computer in which a portrait-mode virtual keyboard according to one embodiment is displayed.

FIG. 14 is an exemplary view showing a virtual keyboard displayed when a “hiragana input mode” select key according to one embodiment is operated.

FIG. 15 is an exemplary view showing a virtual keyboard displayed when an “emoticon input mode” select key according to one embodiment is operated.

FIG. 16 is an exemplary view showing a virtual keyboard displayed when a “picture mark input mode” select key according to one embodiment is operated.

FIG. 17 is an exemplary top plan view showing a computer in which a portrait-mode virtual keyboard according to one embodiment is displayed.

### DETAILED DESCRIPTION

Various embodiments will be described hereinafter with reference to the accompanying drawings.

In general, according to one embodiment, an information processing apparatus includes a first touch screen, a second touch screen display, and a display module. The display module is configured to display a first virtual keyboard comprising first virtual keys in order to input key codes on the first touch screen display, and to display a second virtual keyboard comprising second virtual keys in order to input key codes on the second touch screen display.

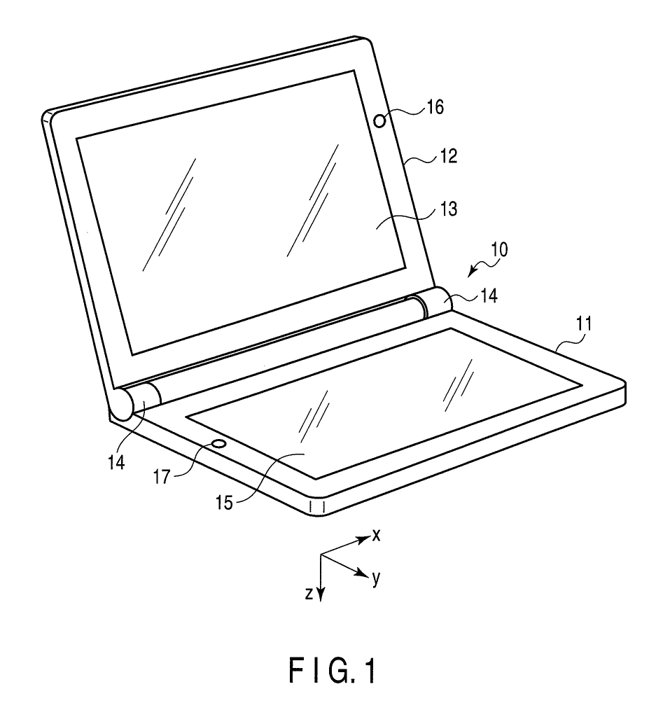

FIG. 1 is a perspective view showing the appearance of an information processing apparatus according to one embodiment. For example, the information processing apparatus is realized as a batter-powered portable personal computer 10.

FIG. 1 is a perspective view showing a state that a display unit of the computer 10 is opened. The computer 10 comprises a computer main body 11 and a display unit 12. A display device formed of a liquid crystal display (LCD) 13 is incorporated into the upper surface of the display unit 12. A display screen of the CD 13 is positioned on the center of the display unit.

The LCD 13 may be realized as a touch screen display, which is capable of sensing a touch area (also calling a touch position) on the display screen of the LCD 13 touched by a pen or finger. User can select various objects (e.g., icons showing folders and files, menus, buttons) displayed on the display screen of the LCD 13 using user's fingertip and a pen. Coordinate data showing a touch area on the display screen is input from the touch screen display to a CPU built in the computer 10.

The display unit 12 has a thin box-shaped housing. This display unit 12 is attached to the computer main body 11 so that the display unit 12 is freely rotatable by means of a hinge member 14. The hinge member 14 is a connecting member configured to connect the display unit 12 with the computer main body 11. Namely, the lower end portion of the display unit 12 is supported to the rear end portion of the computer main body 12 by means of the hinge member 14. Moreover, the display unit 12 is attached to the computer main body 11 so that the display unit 12 is freely rotatable between the following positions. One is an open position in which the upper surface of the computer main body 11 is exposed. The other is a closed position in which the upper surface of the computer main body 11 is covered with the display unit 12. A predetermined position on the upper surface of the display unit 12, for example, the right side on the LCD 13 is provided with a power button 16 for turning on or off the power of the computer 10.

The computer main body 11 is a base unit having a thin box-shaped housing. A liquid crystal display (LCD) 15 functioning as a touch screen display is incorporated into the upper surface of the computer main body 11. A display screen of the LCD 15 is positioned on the center of the computer main body 11. The upper surface of the LCD 15 is provided with a transparent touch panel. A touch screen display is realized by the foregoing LCD 15 and transparent touch panel. This touch screen display is able to sense a touch area (also, calling touch position) on the display screen touched by a pen or finger. The LCD 15 on the computer main body 11 is a display, which is independent from the LCD 13 of the display unit 12. These LCD 13 and 15 are usable as a multi-display for realizing a virtual screen environment. In this case, a virtual screen managed by an operating system of the computer 10 includes a first screen area displayed on the LCD 13 and a second screen area displayed on the LCD 15. An arbitrary application window and an arbitrary object are displayable on each of the foregoing first and second screen areas.

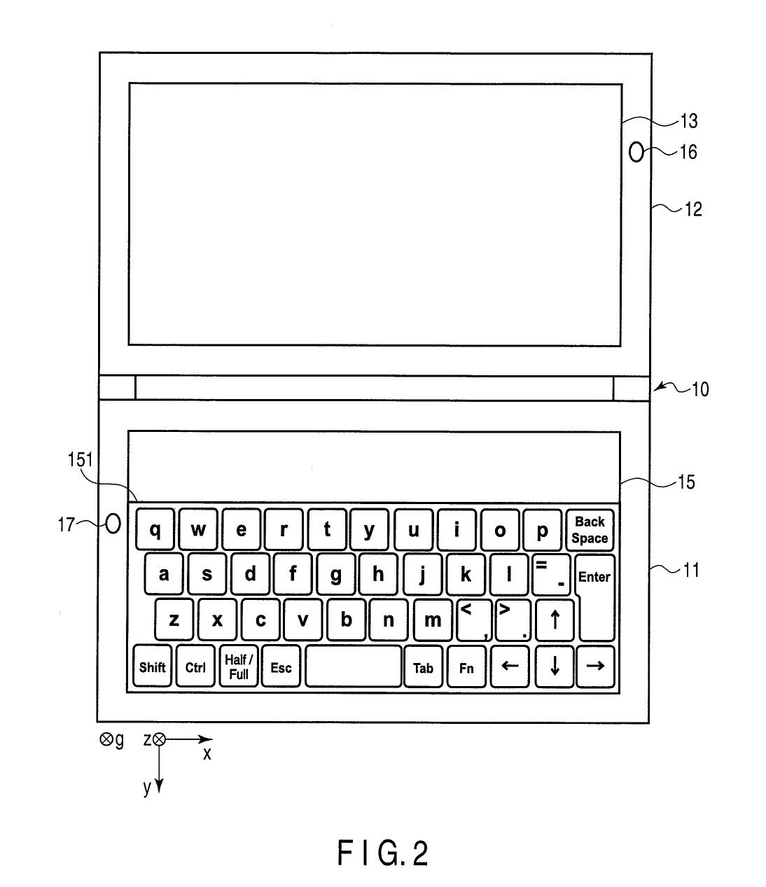

FIG. 2 is a top plan view showing a state that the computer 10 is placed on the horizontal surface. In this state, the acceleration of gravity g is a direction vertical to the paper of FIG. 2.

According to this embodiment, the LCD (touch screen display) provided on the upper surface of the computer main body 11 is used for displaying a virtual keyboard (calling a software keyboard) 151 shown in FIG. 2. For example, the virtual keyboard 151 is displayable on the whole of the display screen of the LCD 15 in full-screen mode. The virtual keyboard 151 includes a plurality of virtual keys (e.g., numeral keys, alphabet keys, arrow keys, auxiliary keys, function keys) for inputting a plurality of key odes. More specifically, the virtual keyboard 151 includes a plurality of buttons (software buttons) corresponding to a plurality of virtual key.

On the other hand, as shown in FIG. 2, the LCD 13 of the display unit 12 is usable as a main display for displaying various application windows. User touches the virtual keyboard displayed on the LCD 15 to input various code data (e.g., key codes, character codes, commands, etc.) to an application window displayed on the LCD 13.

A predetermined position on the upper surface of the computer main body 11, for example, the left side on the LCD 15 is provided with a button switch 17. The button switch 17 is able to assign an arbitrary function. For example, the button switch 17 is usable as a button switch for starting a key input control program, which is an application program for controlling a key input operation using the virtual keyboard. When user presses the button switch 17, a key input control program is started. The key input control program displays a virtual keyboard on the LCD 15. In this case, a display mode shown in FIG. 2 is set as landscape mode.

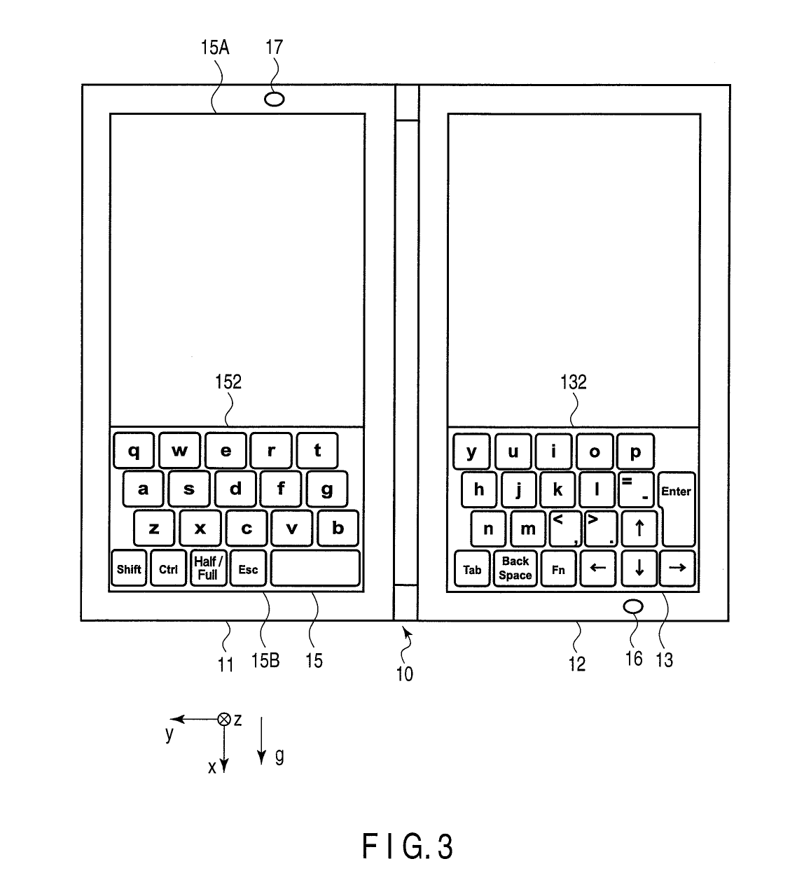

FIG. 3 is a top plan view showing a state that the computer 10 is rotated and user has the computer 10 in his hand. In this state, the acceleration due to gravity g is a direction parallel to the paper of FIG. 3.

As seen from FIG. 3, when the computer is rotated, the foregoing liquid crystal displays 13 and 15 (hereinafter, referred simply to as LCDs 13 and 15) are changed to portrait mode. In this case, virtual keys of the virtual keyboard 151 are displayed in a state of being divided into LCDs 13 and 15. Specifically, a virtual keyboard 152 is displayed on the LCD 15 while a virtual keyboard 132 is displayed on the LCD 13. The virtual keyboard 152 has virtual keys, which are arranged on the left side from segments connecting between “t” and “y”, between “g” and “h”, between “b” and “n” and between “space” and “Tab” of the original virtual keyboard 151. Moreover, the virtual keyboard 152 has virtual keys, which are arranged on the right side from segments connecting between “t” and “y”, between “g” and “h”, between “b” and “n” and between “space” and “Tab” of the original virtual keyboard 151.

According to the portrait mode, when the virtual keyboard 151 is displayed on one LCD, the virtual keyboard 151 is displayed in a state of being reduced. For this reason, the size of virtual keys becomes small; as a result, user is hard to operate the virtual keys. However, the virtual keyboard is displayed in a state of being divided into two parts as described above. This serves to prevent user's operational inconvenience due to virtual keys, which have displayed small. In this case, a display mode shown in FIG. 3 is set as portrait mode.

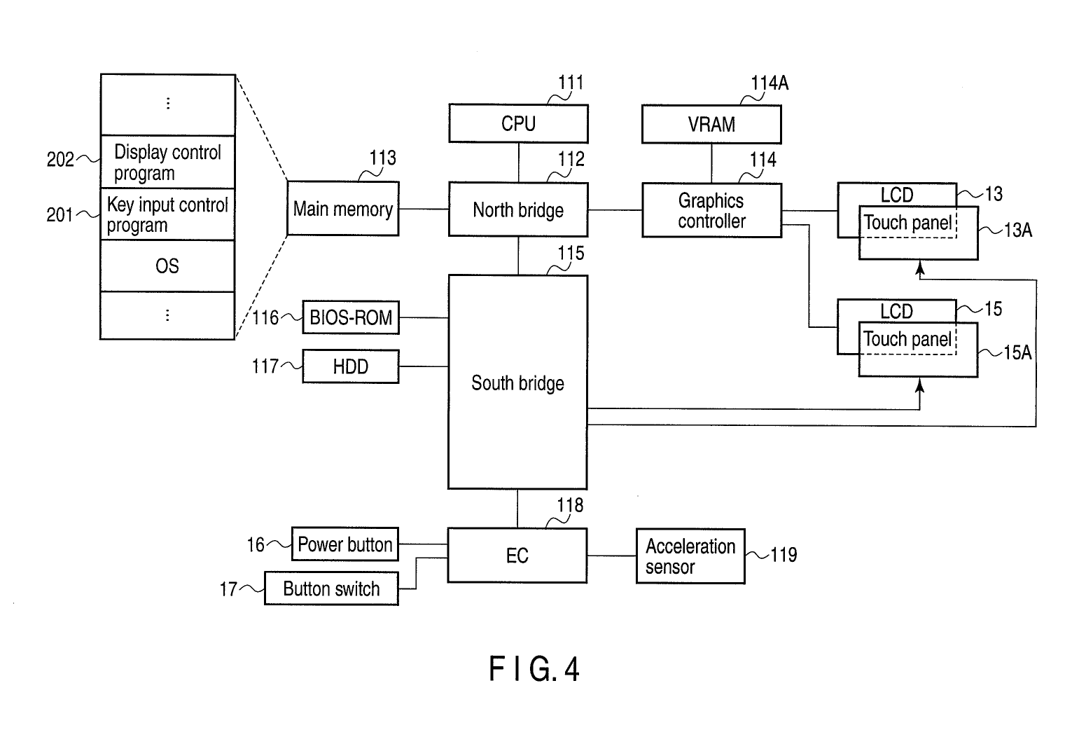

The system configuration of the computer 10 will be described below with reference to FIG. 4. Herein, both of LCDs 13 and 15 are realized as a touch screen display.

The computer 10 includes a CPU 111, a north bridge 112, a man memory 113, a graphics processing unit (GPU) 114, a south bridge 115, a BIOS-ROM 116, a hard disk drive (HDD) 17, an embedded controller (EC) 118 and a three-axis acceleration sensor 119.

The CPU 111 is a processor, which is provided for controlling the operation of the computer 10. The CPU 111 executes an operating system (OS) and various application programs, which are loaded from the HDD 117 to the main memory 113. The foregoing application programs include a key input control program 201 and a display control program 202. The key input control program 201 displays a virtual keyboard 151 on the LCD 15, and then, generates code data in accordance with the touch operation of the virtual keyboard 151 by user. For example, the foregoing generated code data (e.g., key code corresponding to a touched virtual key) is transferred to an active application by way of the operating system (OS). The display control program 202 changes a virtual keyboard displayed on LCDs 13 and 15 in accordance with the gradient of the computer main body 11.

Moreover, the CPU 111 executes a basic input output system (BIOS) stored in the BIOS-ROM 116. The BIOS is a program used for hardware control.

The north bridge 112 is a bridge device, which makes a connection between a local bus of the CPU 111 and the south bridge 115. The north bridge 112 has a built-in memory controller, which controls access t the main memory 113. The GPU 114 is a display controller, which controls two LCDs 13 and 15 used as a display monitor of the computer. The GPU 114 executes a display processing (graphics operation) for drawing display data in a video memory (VRAM) 114A based on a drawing request received from the CPU 111. The following storage areas are assigned to the video memory. One is a storage area for storing display data corresponding to a screen image displayed on the LCD 13. The other is a storage area for storing display data corresponding to a screen image displayed on the LCD 15. The upper surface of the LCD 13 is provided with a transparent touch panel 13A. Likewise, the upper surface of the LCD 15 is provided with a transparent touch panel 15A. Each of the foregoing touch panels 13A and 15A is configured to detect a touch area (touch position) on a touch panel (touch screen display using a resistive film or electrostatic capacitance. Moreover, a multi-touch panel may be used as each of the foregoing touch panels 13A and 15A. The multi-touch panel is able to simultaneously a plurality of touch positions.

The south bridge 115 has a built-in integrated drive electronics (IDE) controller for controlling the HDD 121 and a built-in serial ATA controller. Further, the south bridge 115 has a built-in USB controller for controlling a universal serial bus (USB) apparatus. The embedded controller (EC) 118 has a function of turning on/off the power of the computer 10 in accordance with the operation of the power button switch 16 by user.

The three-axis acceleration sensor 119 detects acceleration. It is possible to detect the gradient of the computer 10 based on the three-axis acceleration sensor 119.

The configuration of the display control program 202 will be described below with reference to FIG. 5.

The display control program 202 includes a tilt determination module 301, a display screen control module 302, and a keyboard display data management module 303. The tilt determination module 301 detects an acceleration direction acceleration of gravity in a still state) with respect to the computer main body in accordance with a detection signal of the three-axis acceleration sensor. Then, the module 301 determines a tilt of the computer main body 11 based on the detected acceleration direction. Usually, if the computer main body 11 is placed on the horizontal plane, the acceleration of x-axis and Y-axis directions is approximately zero “0”. For example, as if user holds a book in his hand, namely, user has the computer main body 11 and the display unit 12 in his hand so that LCDs 13 and 15 are set to portrait orientation. In this case, an absolute value of the acceleration of the x-axis direction becomes large. For example, when user downwardly turns a shorter side 15B facing a shorter side 15A of the LCD 15 adjacent to the button switch 17, the acceleration of the x-axis direction is increased more and more. Conversely, when the shorter side 15B of the LCD 15 adjacent to the button switch 17 is downwardly turned, the acceleration of the x-axis direction is decreased more and more (i.e., the acceleration is increased to the minus direction).

Thus, the tilt determination module 301 determines that the shorter side 15B is downwardly turned if the acceleration of the x-axis direction is more than a preset t (t>0). Conversely, the module 301 determines that the shorter side 15A is downwardly turned if the acceleration of the x-axis direction is more than a preset −t (t>0).

According to this embodiment, it is determined whether the shorter side 15A (shorter side 15B) is downwardly turned using the acceleration of the x-axis direction only. In this case, at least one of the accelerations of x-axis and y-axis directions may be further added as the foregoing determination reference.

The display screen control module 302 executes the control for setting a horizontal display state shown in FIG. 2 or a vertical display state shown in FIG. 3 in accordance with the determination result of the computer main body 11 detected by the tilt determination module 301.

The keyboard display management module 303 sets a horizontal display virtual keyboard 151 or vertical display virtual keyboards 152 and 132 in accordance with a command from the display screen control modules 302.

Moreover, the display screen control module 302 has a function of enlarging and reducing virtual keyboards 152 and 132 in accordance with the operation by user when the computer 10 is in portrait mode. Further, the module 302 has a function of moving virtual keyboards 152 and 132 to change a display position in accordance with the operation by user when the computer 10 is in portrait mode. As described above, the module 302 enlarges and reduces virtual keyboards 152 and 132 or changes a display position in accordance with the operation by user. In this case, when the module 302 enlarges and reduces one of virtual keyboards 152 and 132 or changes a display position of one of virtual keyboards 152 and 132, the other virtual keyboard may be enlarged and reduced or changed in its display position.

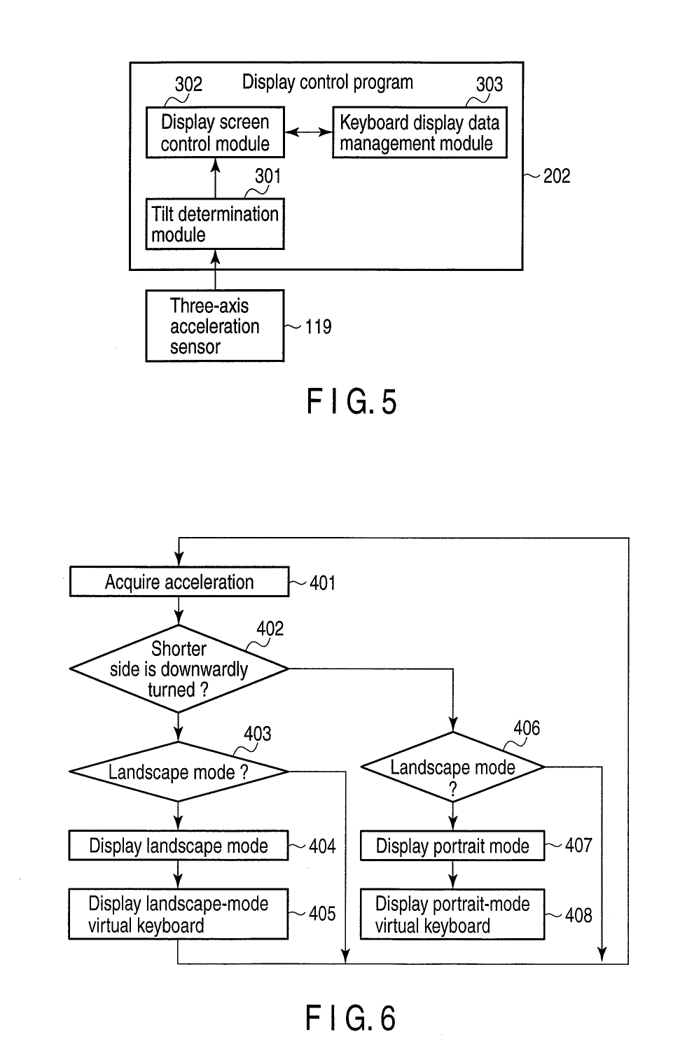

The procedure of making a change of a vertical display state and a horizontal display state will be described below with reference to a flowchart shown in FIG. 6. In this case, a display state just after the computer 10 starts is set to a landscape mode.

The tilt determination module 301 acquires the acceleration of each direction from the three-axis acceleration sensor (step 401). According to this embodiment, acceleration used for determining a tilt is the acceleration of the x-axis direction. Therefore, the module 301 has no need to acquire accelerations of y-axis and z-axis directions. Then, the module 301 determines whether or not the shorter side 15A or 15B is downwardly turned based on the acquired acceleration (step 402).

The display screen control module 302 determines whether or not the shorter side 15A or 15B is downwardly turned based on the determination result of the tilt determination module 301 (step 403). If it is determined that the shorter side 15A or 15B is not downwardly turned (No in step 403), the module 302 determines whether or not the current display state is in landscape mode (step 404). If it is determined that the current display state is not in landscape mode (No in step 404), the module 302 displays landscape mode on LCDs 13 and 15 (step 404). Then, the module 302 gives instructions to provide data of a landscape-mode virtual keyboard 151 to the keyboard display data management module 303. Then, when the module 303 provides the data of the virtual keyboard 151, the display screen control module 302 displays the virtual keyboard 151 on the LCD 15 (step 405).

In step 403, if it is determined that the shorter side 15A or 15B is downwardly turned (Yes in step 403), the module 302 determines whether or not the current display state is in portrait mode (step 406). If it is determined that the current display state is not in portrait mode (No in step 406), the display screen control module 302 displays portrait-mode display on the LCDs 13 and 15 (step 407). The module 302 makes a display corresponding to the shorter side, which is determined as being downwardly turned. In this case, the module 302 does not display a virtual display. Thereafter, the module 302 gives instructions to provide data for displaying landscape-format virtual keyboards 132 and 152 to the keyboard display data management module 303. Then, when the module 303 provides provide data for displaying these virtual keyboards 132 and 152, the display screen control module 302 displays these virtual keyboards 132 and 152 on LCDs 13 and 15, respectively (step 408). In this case, the position of virtual keyboards 132 and 152 displayed when the shorter side 15A is downwardly turned and the position of virtual keyboards 132 and 152 displayed when the shorter side 15B is downwardly turned are relatively the same.

The foregoing procedure is performed, and thereby, a change of the display of the landscape-mode virtual keyboard 151 and the display of portrait-mode virtual keyboards 132 and 152 is achieved.

A modification example of a landscape-mode virtual keyboard and a portrait-mode virtual keyboard will be described below.

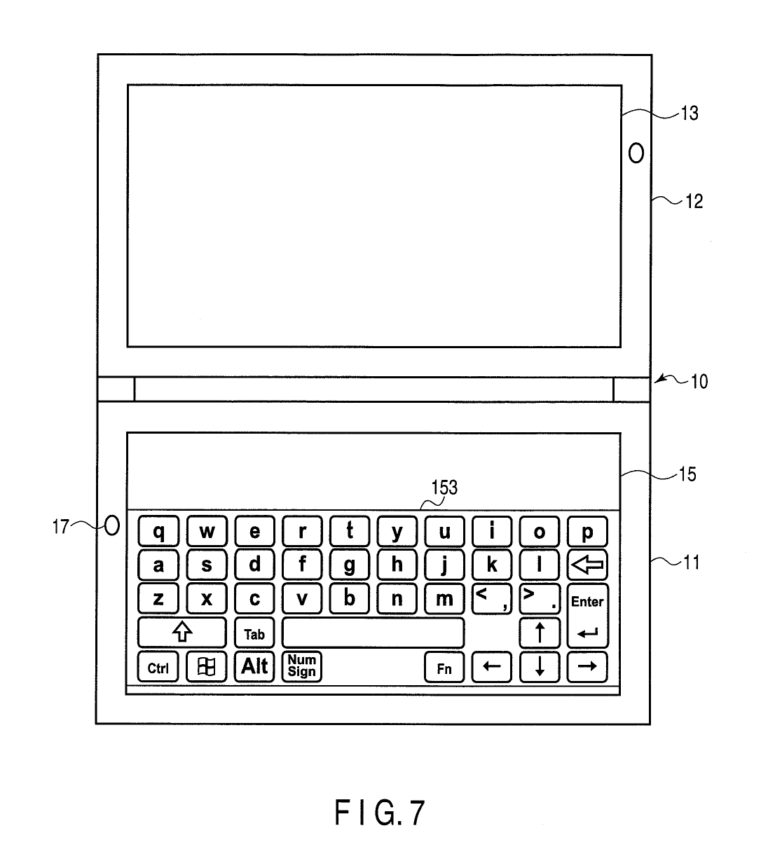

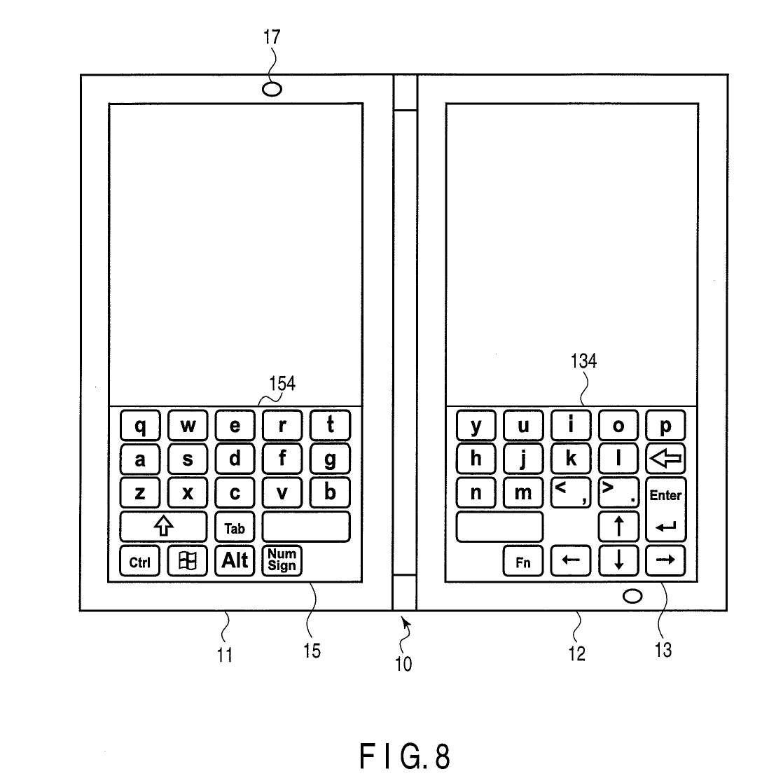

FIG. 7 is a top plan view showing a computer 10 in which a landscape-mode virtual keyboard 153 is displayed. FIG. 8 is a top plan view showing a computer 10 in which the computer 10 shown in FIG. 7 is rotated so that portrait-mode virtual keyboards 134 and 154 are displayed.

As can be seen from FIGS. 7 and 8, keys are arranged like a matrix on each of virtual keyboards 153, 134 and 154. Keys arranged on the virtual keyboard 134 are the same as keys arranged on the virtual keyboard 132. Moreover, keys arranged on the virtual keyboard 154 are the same as keys arranged on the virtual keyboard 152.

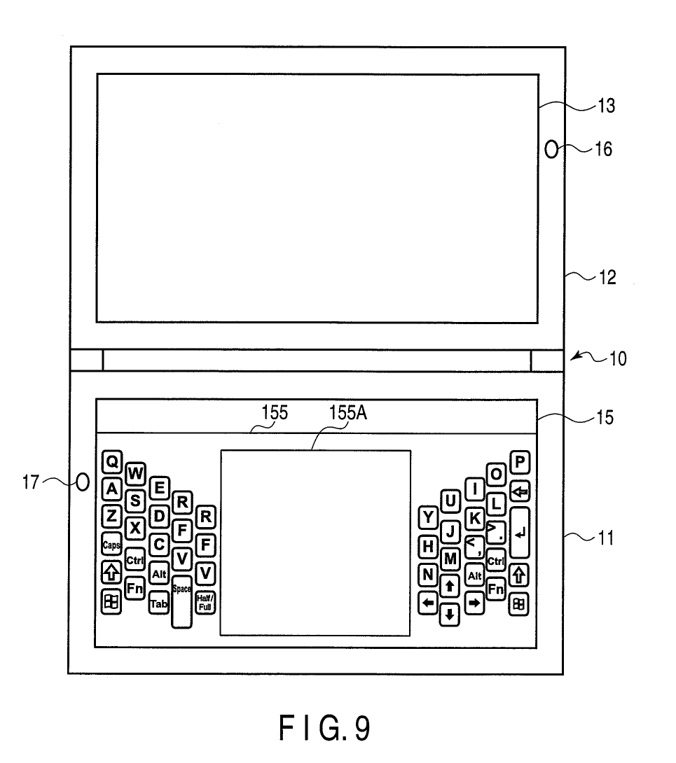

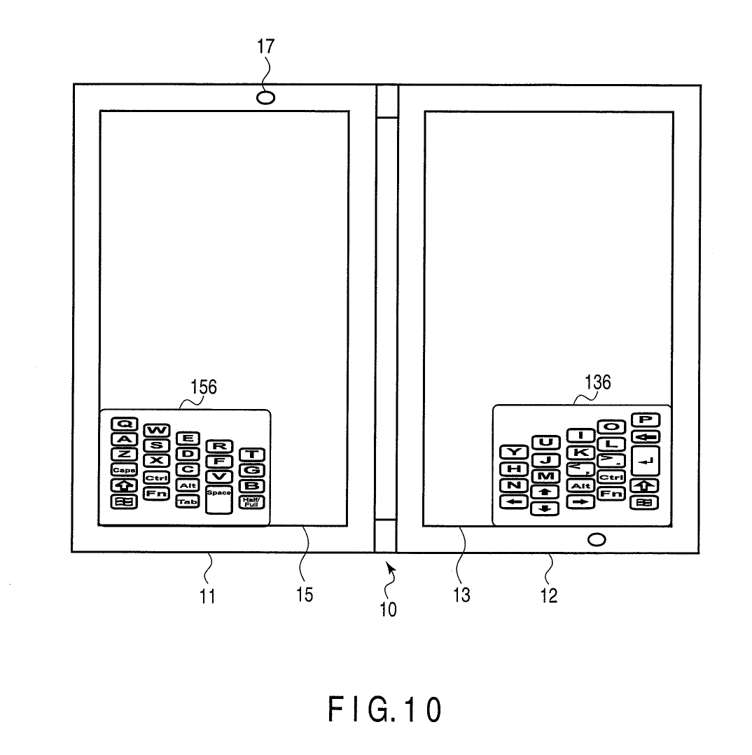

FIG. 9 is a top plan view showing a computer 10 in which a landscape-mode virtual keyboard 155 is displayed. FIG. 10 is a top plan view showing a computer 10 in which the computer 10 shown in FIG. 9 is rotated so that portrait-mode virtual keyboards 136 and 156 are displayed.

The foregoing virtual keyboards 155, 136 and 156 are shown as an example of employing a so-called ergonomic keyboard. In the virtual keyboard shown in FIG. 9, a virtual touch pad 155A is displayed between keys operated by user's right hand and keys operated by user's left hand. In portrait mode, the foregoing virtual touch pad is not displayed. Moreover, in portrait mode, a virtual touch pad is displayed on the LCD 13 or 15 between virtual keyboards 136 and 156. According to a state that user has the computer 10 in his both hands; user's finger is hard to reach the virtual touch pad. For this reason, the virtual touch pad is operated as a normal display area without displaying anything; in this way, user's availability is improved.

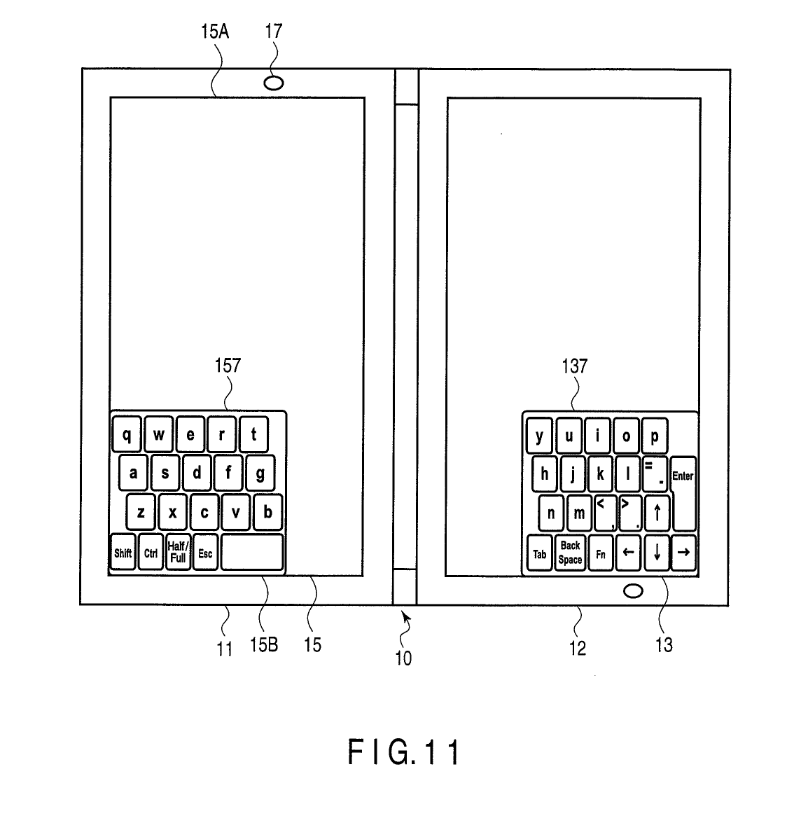

FIG. 11 is a top plan view showing a computer 10 in which portrait-mode virtual keyboards 137 and 157 are displayed. A left side on the virtual keyboard 137 in which user's finger is hard to reach and a right side on the virtual keyboard 157 in which user's finger is hard to reach are provided with an area in which an image is displayed, as well as virtual keyboards 136 and 156 shown in FIG. 10.

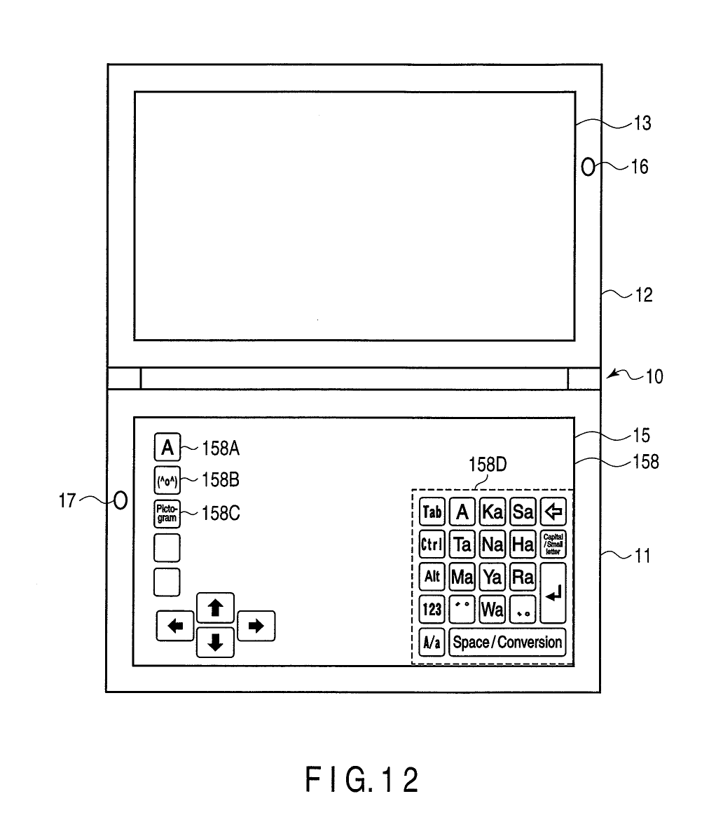

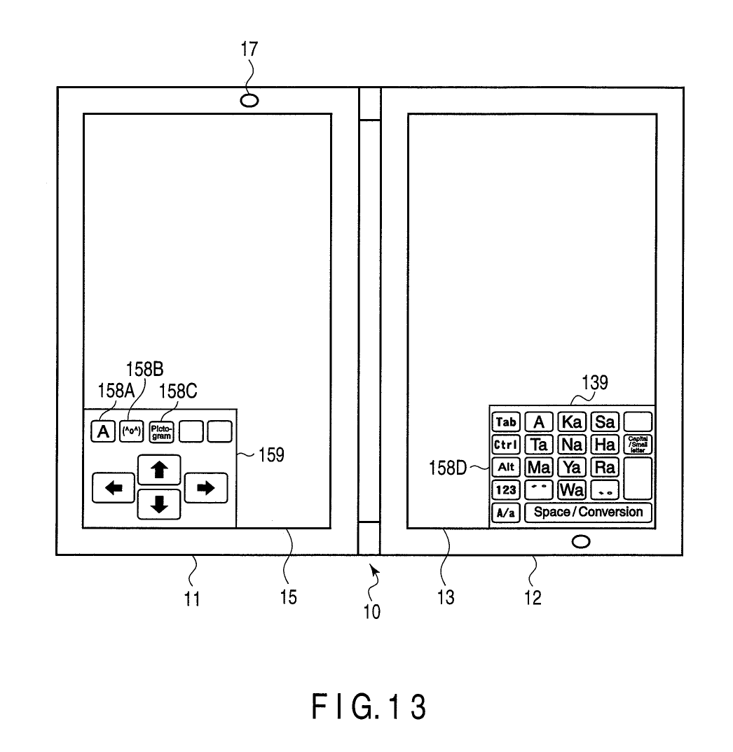

FIG. 12 is a top plan view showing a computer 10 in which a landscape-mode virtual keyboard 158 is displayed. FIG. 13 is a top plan view showing a computer 10 in which portrait-mode virtual keyboards 139 and 159 are displayed.

FIGS. 12 and 13 show an example in which a mobile phone software keyboard is applied to a virtual keyboard of this embodiment. According to the landscape mode shown in FIG. 12, the following keys are displayed on a screen. One is a “Hiragana input mode” select key 158A, another is a “face mark input mode” select key 158B, and another is a “picture mark input mode” select key 158C. In addition, an input key area 158D for displaying “selected mode input keys” is displayed on the same screen as above. User has a feeling as if user operates a mobile phone; therefore, this serves to provide an easily usable input specification. When the screen input specification is turned to portrait mode, the foregoing select keys 158A, 158B and 158C are arranged in a virtual keyboard 159 displayed on the left-side LCD 15. Moreover, the input key area 158D is arranged in a virtual keyboard 139 displayed on the right-side LCD 13.

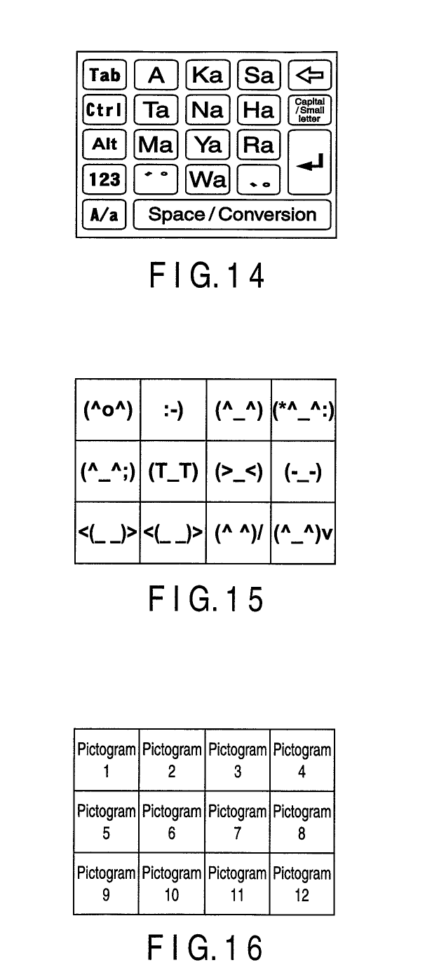

In this case, when the foregoing “Hiragana input mode” select key 158A is operated, virtual key shown in FIG. 14 are displayed on the input key area 158D. Further, when the foregoing “face mark input mode” select key 158B is operated, virtual key shown in FIG. 15 are displayed on the input key area 158D. Furthermore, when the foregoing “picture mar input mode” select key 158C is operated, virtual key shown in FIG. 16 are displayed on the input key area 158D. In this case, an image is actually displayed in each of “picture mark 1” to “picture mark 12” shown in FIG. 16.

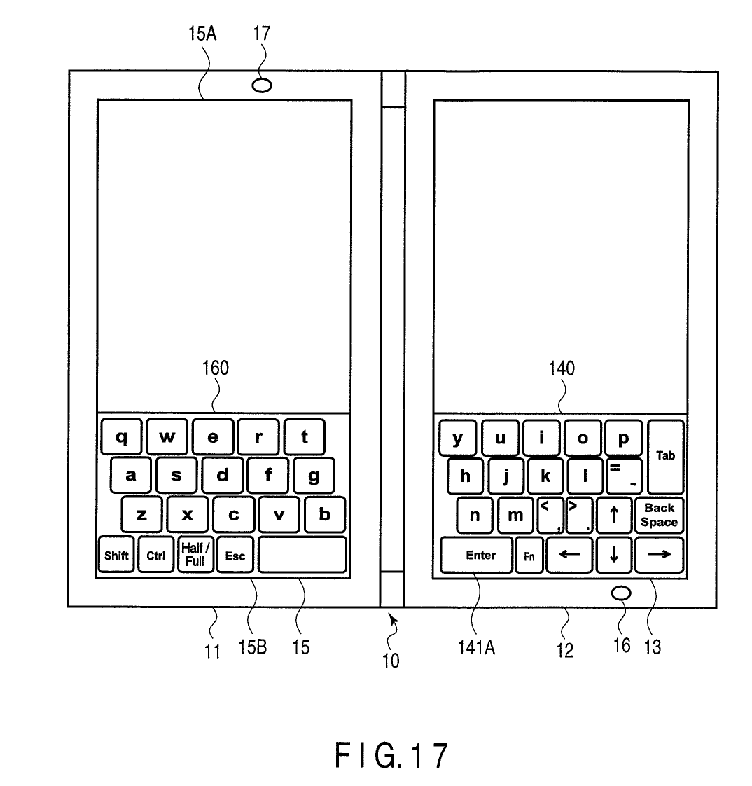

FIG. 17 is a top plan view showing a computer 10 in which portrait-mode virtual keyboards 140 and 160 are displayed.

An “Enter key” 151A of the landscape-mode virtual keyboard shown in FIG. 2 is displayed on the right end of the LCD 15. When the landscape-mode virtual keyboard shown in FIG. 2 is changed to portrait mode, a key (i.e., “Enter key” 114A) having an input frequency lower than general keys is arranged in the vicinity of a space key arranged on the center in which user's finger is hard to reach in the virtual keyboard 160. As described above, the key 114A having a low input frequency is arranged at a position where user's finger is hard to reach, and thereby, this serves to improve user's availability.

According to the foregoing embodiment, when a display mode is changed from landscape mode to portrait mode and when it is changed from portrait mode to landscape mode, the virtual keyboard is automatically displayed. In this case, user operates the button switch 17, and thereafter, the virtual keyboard may be displayed.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and spirit of the inventions.

What is claimed is:

1. An information processing apparatus comprising:
a first touch screen display;
a second touch screen display; and
a display module configured to display a first virtual keyboard comprising one or more first virtual keys and to display a second virtual keyboard comprising one or more second virtual keys,
wherein the one or more first virtual keys are configured to input key codes on the first touch screen display, and
wherein the one or more second virtual keys are configured to input key codes on the second touch screen display.

2. The apparatus of claim 1, further comprising:
a first housing having the first touch screen display;
a second housing having the second touch screen display; and
a hinge rotatably connecting an end portion of the first housing to an end portion of the second housing,
wherein the first touch screen display comprises a first shorter side and a first longer side extending along the end portion of the first housing, and
wherein the second touch screen display comprises a second shorter side and a second longer side extending along the end portion of the second housing.

3. The apparatus of claim 2, further comprising:
a detector configured to detect a tilt of the first housing,
wherein the display module is further configured to display the first virtual keyboard on the first touch screen display while displaying the second virtual keyboard on the second touch screen display when the detector detects that the first shorter side of the first touch screen display is downwardly tilted.

4. The apparatus of claim 3, wherein the display controller is further configured to display a third virtual keyboard including one or more third virtual keys when the detector detects that the first side of the first touch screen display is not downwardly or upwardly tilted,
wherein the one or more third virtual keys are configured to input key codes.

5. The apparatus of claim 4, wherein the one or more third virtual keys comprise the one or more first virtual keys and the one or more second virtual keys.

6. The apparatus of claim 3, wherein the display module is further configured to display the second virtual keyboard on the first touch screen display while displaying the first virtual keyboard on the second touch screen display when the detection module detects that the first shorter side of the first touch screen display is upwardly tilted.

7. The apparatus of claim 1, wherein the display module is further configured to change the size of the first virtual keyboard and the second virtual keyboard.

8. The apparatus of claim 1, wherein the display module is further configured to change a display position of the first virtual keyboard and the second virtual keyboard.

9. A method of controlling a display of an information processing apparatus, the apparatus comprising a first touch screen display and a second touch screen display, the method comprising:
displaying a first virtual keyboard comprising one or more first virtual keys, the one or more first virtual keys configured to input key codes on the first touch screen display; and
displaying a second virtual keyboard comprising one or more second virtual keys, the second virtual keys configured to input key codes on the second touch screen display.

10. A non-transitory, computer-readable, medium comprising computer executable instructions, which when executed, cause a computer to perform a method of controlling a display of an information processing apparatus, the method comprising:
displaying a first virtual keyboard comprising one or more first virtual keys, the one or more first virtual keys configured to input key codes on a first touch screen display; and
displaying a second virtual keyboard comprising one or more second virtual keys, the one or more second virtual keys configured to input key codes on a second touch screen display,
wherein the computer comprises the first touch screen display and the second touch screen display.
